(19) United States
(12) Patent Application Publication
(10) Pub. No.: US 2025/0231098 A1
(43) Pub. Date: Jul. 17, 2025

(54) METHOD AND COMPUTER PROGRAM FOR PREDICTING PARAMETER OF SAMPLE IN OPTICAL MEASUREMENT SYSTEM, AND RECORDING MEDIUM STORING COMPUTER PROGRAM FOR IMPLEMENTING SAME

(71) Applicant: INDUSTRY-ACADEMIC COOPERATION FOUNDATION, YONSEI UNIVERSITY, Seoul (KR)

(72) Inventors: Young-Joo KIM, Seoul (KR); Juwon JUNG, Seoul (KR); Kibaek KIM, Seoul (KR); NaGyeong KIM, Seoul (KR)

(21) Appl. No.: 18/989,928

(22) Filed: Dec. 20, 2024

(30) Foreign Application Priority Data
Jan. 16, 2024 (KR) 10-2024-0006683
Dec. 13, 2024 (KR) 10-2024-0185854

(51) Int. Cl. G01N 21/21

(52) U.S. Cl. CPC G01N 21/211; G01N 2201/1293; G01N 2201/1296

(57) ABSTRACT

An embodiment provides a method and a computer program for predicting a parameter of a sample in an optical measurement system, and a recording medium storing the computer program for implementing the same, wherein the method includes: generating library spectral distribution data; supervising learning an artificial neural network with the library spectral distribution data; inputting measurement spectral distribution data acquired by measuring a sample; generating synthetic data by combining the measurement spectral distribution data and similar library spectral distribution data that are similar to the library spectral distribution data; inputting the synthetic data into the supervised learning artificial neural network to predict relative structural parameter coordinates; and combining similar variable measurement parameter coordinates for the similar library spectral distribution data and the predicted relative structural parameter coordinates to output actual variable parameter coordinates.

### CROSS-REFERENCE TO RELATED APPLICATIONS

This application claims the priority of Korean Patent Application Nos. 10-2024-0006683 filed on Jan. 16, 2024 and 10-2024-0185854 filed on Dec. 13, 2024, in the Korean Intellectual Property Office, the disclosure of which is incorporated herein by reference.

### BACKGROUND

The disclosure relates to a method and a computer program for predicting a parameter of a sample in an optical measurement system, and a recording medium storing the computer program for implementing the same. More specifically, the disclosure relates to a method and a computer program for predicting a parameter of a sample in an optical measurement system, capable of rapid analysis of a sample without a process of obtaining a theoretical spectral distribution, and a recording medium storing the computer program.

As science advances, nanotechnology, which controls and manipulates materials at the atomic and molecular levels, is gaining attention. Nano is a prefix meaning one billionth, and nanometer (nm) represents a length equal to one billionth of a meter. In this microscopic world, materials have unique physical and chemical properties that are different from those in the macroscopic world. Nanotechnology is utilizing these properties to create innovation in various fields such as new material development, electronics, and medicine.

In order to develop this nanotechnology, a measuring instrument that accurately investigates the properties of materials at the nanometer scale is needed. An optical measurement system is a system that investigates the properties of materials using light, and includes ellipsometry, reflectometry, polarimetry, and scatterometry.

Meanwhile, there are several difficulties in applying optical measurement systems to analyze nano-sized structures, among which the key is to obtain accurate measurements from the double structure and to quickly identify its shape based on these measurements. To solve the latter difficulty, some studies perform data analysis using nonlinear regression analysis using artificial neural network models.

Meanwhile, selecting an appropriate starting point for nonlinear regression analysis has a significant impact on the computational workload and processing time. However, in the artificial neural network model, there was a problem that the reliability of the measurement results was reduced due to incorrect selection of the starting point.

Therefore, a solution to solve these problems was needed.

### RELATED ART DOCUMENT

### Patent Document

Republic of Korea Patent No. 10-2431942 (20220809)

### SUMMARY

An aspect of the disclosure is to provide a method and a computer program for predicting a parameter of a sample in an optical measurement system, and a recording medium storing a computer program for implementing the same, wherein included are: generating library data reflecting the material composition, optical characteristics, and structural features of a sample; inputting a measurement spectral distribution obtained by measuring a sample, and output structural parameters and optical parameters corresponding to values most similar to the library spectral distribution data; and applying synthetic data that combines the corresponding library spectral distribution data with the measurement spectral distribution to a supervised-learning artificial neural network to output final actual variable parameters.

The aspect of the disclosure is not limited to that mentioned above, and other aspects not mentioned will be clearly understood by those skilled in the art from the description below.

A method of the disclosure includes: (a) generating library spectral distribution data; (b) supervising learning an artificial neural network with the library spectral distribution data; (c) inputting measurement spectral distribution data acquired by measuring a sample; (d) generating synthetic data by combining the measurement spectral distribution data and similar library spectral distribution data that are similar to the library spectral distribution data; (e) inputting the synthetic data into the supervised learning artificial neural network to predict relative structural parameter coordinates; and (f) combining similar variable measurement parameter coordinates for the similar library spectral distribution data and the predicted relative structural parameter coordinates to output actual variable parameter coordinates.

In an embodiment of the disclosure, (a) may include: (a1) assuming structural features and optical features for the sample; (a2) determining the number of library variables for the assumed structural features and optical features; and (a3) forming coordinates on a plane composed of a plurality of library variable parameters according to the number of library variables, wherein in (a3), the plane is a plane in which the x-axis is the height of the sample and the y-axis is the width of the sample.

In an embodiment of the disclosure, (a) may include: (a4) forming a plurality of grids having preset intervals on the plane in the direction of the plurality of library variable parameters; (a5) obtaining a spectral distribution for library variable parameter coordinates located at each vertex of the plurality of grids based on the preset intervals for each of the plurality of grids; and (a6) generating the library spectral distribution data by dividing and storing library variable parameters obtained from the spectral distribution for the library variable parameter coordinates for each of the plurality of grids, wherein the grid has a shape of an n-dimensional regular polytope (wherein, n is a natural number greater than or equal to 2).

In an embodiment of the disclosure, (b) may include: (b1) selecting similar library variable parameter coordinates corresponding to a similar spectral distribution that is close to the measurement spectral distribution among the plurality of library variable parameters and defining the coordinates as 0-order coordinates; (b2) defining coordinates shifted in the positive direction by the preset interval based on the similar library variable parameter coordinates as +1-order coordinates; (b3) defining coordinates shifted in the negative direction by the preset interval based on the similar library variable parameter coordinates as −1-order coordinates; and (b4) supervising learning the artificial neural network to derive the relative structural parameter coordinates based on the measurement spectral distribution, the spectral distribution corresponding to the +1-order coordinates, and the spectral distribution corresponding to the −1-order coordinates.

In an embodiment of the disclosure, (d), in which the measurement spectral distribution data may include the measurement spectral distribution, may include: (d1) selecting similar library variable measurement parameter coordinates corresponding to a similar measurement spectral distribution that is close to the measurement spectral distribution among the plurality of library variable parameters and defining the coordinates as 0-order measurement coordinates; (d2) defining coordinates shifted in the positive direction by the preset interval based on the similar library variable measurement parameter coordinates as +1-order measurement coordinates; (d3) defining coordinates shifted in the negative direction by the preset interval based on the similar library variable measurement parameter coordinates as −1-order measurement coordinates; and (d4) generating the synthetic data by combining the measurement spectral distribution, the spectral distribution corresponding to the +1-order measurement coordinates, and the spectral distribution corresponding to the −1-order measurement coordinates.

In addition, the disclosure provides a recording medium storing a computer program for implementing the method for predicting a parameter of a sample in an optical measurement system as described above.

In addition, the disclosure provides a computer program stored on a recording medium for implementing the method for predicting a parameter of a sample in an optical measurement system as described above.

The effects of the disclosure are that, by generating library data reflecting the material composition, optical characteristics, and structural features of a sample, receiving the measurement spectral distribution obtained by measuring a sample to output structural parameters and optical parameters corresponding to the most similar values to the library spectral distribution data, and applying synthetic data that combines the corresponding library spectral distribution data with the measurement spectral distribution to a supervised learning artificial neural network to output the final actual variable parameters, analysis of the structural information, optical information, and material information of the sample is possible, a process of obtaining the theoretical spectral distribution in the analysis process performed in the conventional technology is omitted, so that rapid analysis is possible, and accurate prediction is possible even if the interval constituting the library is not made very small.

The effects of the disclosure are not limited to the effects described above, and should be understood to include all effects that are inferable from the configuration of the disclosure described in the detailed description or claims of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a flow chart illustrating a process of predicting a parameter of a sample in an optical measurement system according to an embodiment of the disclosure;

FIG. 2A is a conceptual diagram illustrating a spectroscopic ellipsometer of an optical measurement system according to an embodiment of the disclosure.

FIG. 2B is a conceptual diagram illustrating a server for analyzing and interpreting data according to an embodiment of the disclosure;

FIG. 3 is a block diagram illustrating an algorithm for predicting a parameter of a sample in an optical measurement system according to an embodiment of the disclosure;

FIGS. 4A and 4B are conceptual diagrams illustrating a plane where variable parameters are located, a plurality of grids dividing the plane, and intersections of variable parameters where the plurality of grids intersect, according to an embodiment of the disclosure; and

FIG. 5 is a conceptual diagram illustrating an operation of receiving synthetic data in an artificial neural network according to an embodiment of the disclosure and predicting relative structural parameter coordinates.

### DETAILED DESCRIPTION

Hereinafter, the disclosure will be described with reference to the accompanying drawings. However, the disclosure may be implemented in various different forms, and therefore is not limited to the embodiments described herein. In addition, in order to clearly describe the disclosure in the drawings, parts that are not related to the description are omitted, and similar parts are given similar drawing reference numerals throughout the specification.

In the entire specification, when a part is said to be “connected (linked, contacted, coupled)” to another part, this includes not only the case where it is “directly connected” but also the case where it is “indirectly connected” with another member in between. In addition, when a part is said to “include” a certain component, this does not mean that other components are excluded unless otherwise specifically stated, but that other components may be additionally provided.

The terms used in this specification are used only to describe specific embodiments and are not intended to limit the disclosure. The singular expression includes the plural expression unless the context clearly indicates otherwise. In this specification, the terms “include” or “have” are intended to specify the presence of a feature, number, step, operation, component, part, or combination thereof described in the specification, but should be understood as not excluding in advance the possibility of the presence or addition of one or more other features, numbers, steps, operations, components, parts, or combinations thereof.

Hereinafter, embodiments of the disclosure will be described in detail with reference to the accompanying drawings.

An optical measurement system according to an embodiment of the disclosure includes an ellipsometer, a reflectometer, a polarimeter, and a scatterometer.

Meanwhile, the process of inverse reconstruction from the measurement data in the ellipsometer is based on a thorough analysis approach such as the least squares regression method, and iterative adjustments are required until the calculated ellipsometric spectrum approximates the actual measured data. This iterative approach can improve accuracy, but it lengthens the regression analysis process because iterative calculations are required after configuring the optical simulation. As a result, real-time analysis of this method in actual applications is still limited, especially in the case of complex structural forms such as lattice nanostructures.

The conventional technology measures the spectral distribution (e.g., Mueller matrix) of a specimen, and analyzes the spectral distribution data by finding theoretical data corresponding to the assumed parameters with the smallest difference from the measured data based on the gradient, and then conducting the analysis by finding the final predicted parameters through numerous trials. This method requires a long analysis time in a process of performing multiple trials by sequentially changing parameters, calculating the theoretical spectral distribution, and comparing the spectral distribution with the measurement spectral distribution.

Accordingly, much effort has been made in the field of spectroscopic ellipsometers to reduce the analysis time and improve accuracy. In particular, much effort has been made to improve the search process within library data during spectroscopic ellipsometer data analysis. These efforts are for simplifying the search process to accelerate the analysis of measured data. In addition, some studies have utilized machine learning or deep learning technology as an innovative approach to accelerate data analysis.

In fact, selecting an appropriate starting point for nonlinear regression analysis has a significant impact on the computational workload and processing time. As a strategy to accelerate this process, a method has been adopted to effectively identify the optimal starting point and shorten the processing time by utilizing an artificial neural network.

However, when using an artificial neural network model, the reliability of the measurement results has been reduced because there is a possibility of selecting the wrong starting point. An embodiment of the disclosure proposes a method for accurately predicting a starting point so that reliability is not reduced.

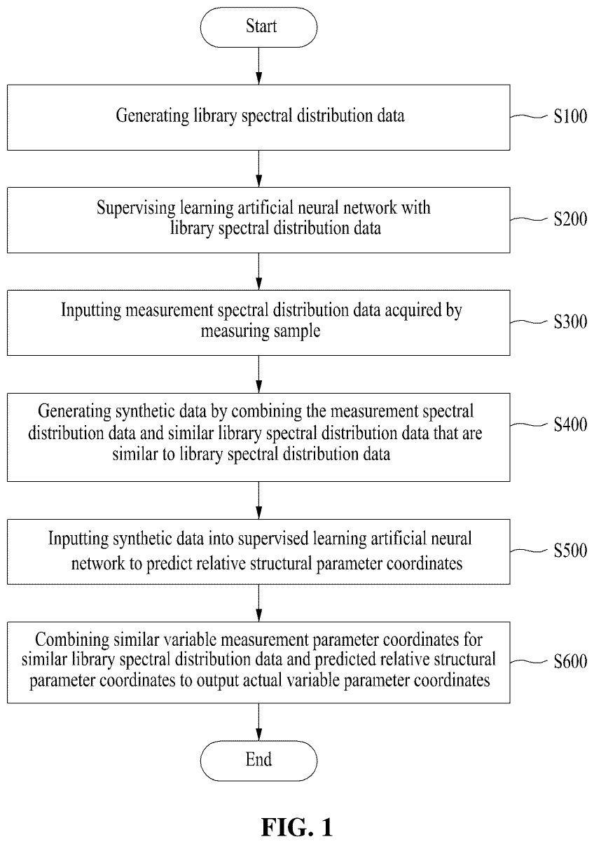

Hereinafter, a method for predicting a parameter of a sample in an optical measurement system according to an embodiment of the disclosure will be described with reference to FIGS. 1 to 5.

FIG. 1 is a flowchart illustrating a method for predicting a parameter of a sample in an optical measurement system according to an embodiment of the disclosure.

Referring to FIG. 1, a method for predicting a parameter of an optical measurement system sample according to an embodiment of the disclosure includes: (a) generating library spectral distribution data (S100); (b) supervising learning an artificial neural network with the library spectral distribution data (S200); (c) inputting measurement spectral distribution data acquired by measuring a sample (S300); (d) generating synthetic data by combining the measurement spectral distribution data and similar library spectral distribution data that are similar to the library spectral distribution data (S400); (e) inputting the synthetic data into the supervised learning artificial neural network to predict relative structural parameter coordinates (S500); and (f) combining similar variable measurement parameter coordinates for the similar library spectral distribution data and the predicted relative structural parameter coordinates to output actual variable parameter coordinates (S600). For example, the spectral distribution data may be a Mueller matrix.

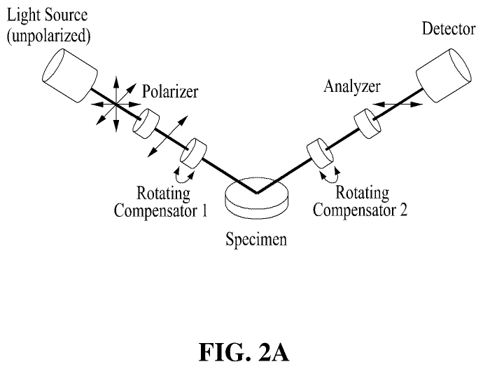

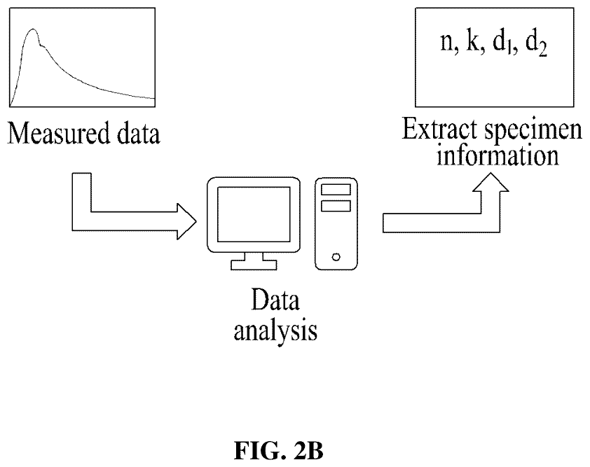

FIG. 2A is a conceptual diagram illustrating an ellipsometer according to an embodiment of the disclosure. FIG. 2B is a conceptual diagram illustrating a server for analyzing and interpreting data according to an embodiment of the disclosure.

First, a spectroscopic ellipsometer among ellipsometers according to an embodiment of the disclosure will be described.

Referring to FIG. 2A, a spectroellipsometer includes an unpolarized light source positioned above one side of a sample to irradiate light to the sample, a fixed polarizer polarizing the light irradiated from the light source, a first rotating compensator 1 compensating for light polarized from the fixed polarizer while rotating, a second rotating compensator 2 compensating for light reflected from the sample, an analyzer analyzing the light compensated by the second rotating compensator, and a detector detecting the light analyzed from the analyzer.

The spectroellipsometer illustrated in FIG. 2A analyzes and detects the sample, and transmits the acquired measured data to the server illustrated in FIG. 2B, and the server analyzes the measured data to extract information about the sample.

That is, the disclosure extracts information about a sample through a server based on data measured from a spectroscopic ellipsometer, and a method for predicting a parameter of a sample in an optical measurement system according to an embodiment of the disclosure for this will be described in detail below.

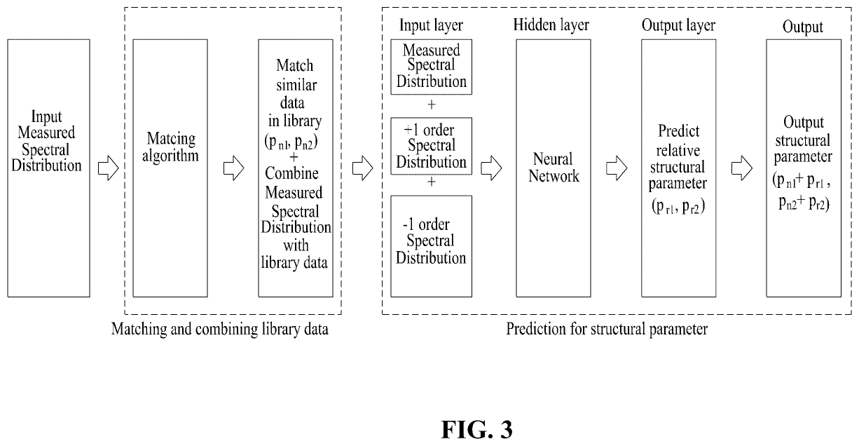

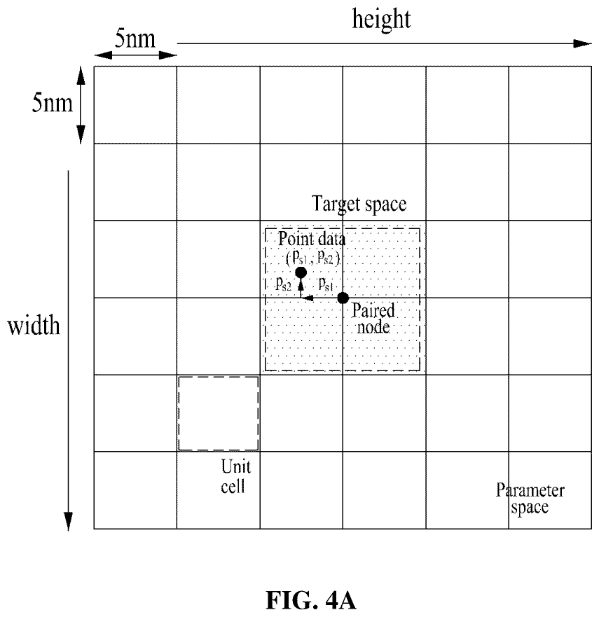

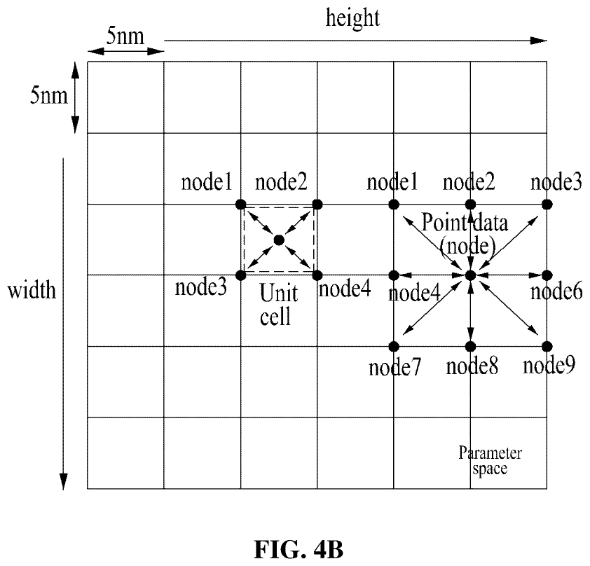

FIG. 3 is a block diagram illustrating an algorithm for predicting a parameter of a sample in a server according to an embodiment of the disclosure. FIGS. 4A and 4B are conceptual diagrams illustrating a plane where variable parameters are located, a plurality of grids dividing the plane, and intersections of variable parameters where the plurality of grids intersect, according to an embodiment of the disclosure.

Referring to FIGS. 3 and FIGS. 4A and 4B, (a) includes: (a1) assuming structural features and optical features of a sample; (a2) determining the number of library variables for the assumed structural features and optical features; and (a3) forming coordinates on a plane (=parameter space) composed of a plurality of library variable parameters according to the number of library variables.

Specifically, referring to FIGS. 4A and 4B, in (a3), the plane is a plane in which the x-axis is the height of the sample and the y-axis is the width of the sample.

In addition, referring to FIG. 4B, (a) includes: (a4) forming a plurality of grids (=unit cells) having preset intervals on a plane in the direction of a plurality of library variable parameters; (a5) obtaining a spectral distribution for library variable parameter coordinates (=node1, node2, node3, node4, node5, node6, node7, node8, node9) located at each vertex of a plurality of grids based on the preset intervals for each of the plurality of grids; and (a6) generating the library spectral distribution data by dividing and storing library variable parameters obtained from the spectral distribution for the library variable parameter coordinates for each of the plurality of grids.

In (a4), the preset interval means the x-axis length and the y-axis length for one grid.

Specifically, the preset interval may be 5 nm as shown in FIGS. 4A and 4B, and the grid has a square shape.

Next, (b) includes: (b1) selecting similar library variable parameter coordinates (=paired node) corresponding to a similar spectral distribution that is close to the measurement spectral distribution among the plurality of library variable parameters and defining the coordinates as 0-order coordinates; (b2) defining coordinates shifted in the positive direction by the preset interval based on the similar library variable parameter coordinates as +1-order coordinates; (b3) defining coordinates shifted in the negative direction by the preset interval based on the similar library variable parameter coordinates as −1-order coordinates; and (b4) supervising learning the artificial neural network to derive the relative structural parameter coordinates based on the measurement spectral distribution, the spectral distribution corresponding to the +1-order coordinates, and the spectral distribution corresponding to the −1-order coordinates.

In (b1), the measurement spectral distribution is a spectral distribution obtained by measuring a sample made of the same material as the sample to be measured in (c).

In addition, in (b2), the +1 order coordinates mean coordinates that have moved by a preset interval in the positive (+) x-axis direction and the positive (+) y-axis direction from the 0-order coordinates.

In addition, in (b3), the −1 order coordinates mean coordinates that have moved by a preset interval in the negative (−) x-axis direction and the negative (−) y-axis direction from the 0-order coordinates.

(a) and (b) are preceding steps performed before the measurement spectral distribution illustrated in FIG. 3 is input (input measurement spectral distribution).

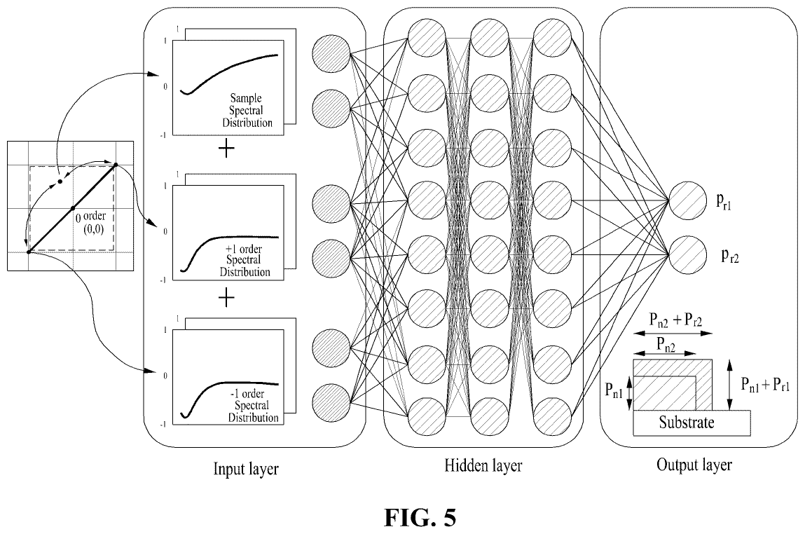

FIG. 5 is a conceptual diagram showing a method for predicting a parameter of an optical measurement system sample according to an embodiment of the disclosure, in which synthetic data is input to an artificial neural network that has undergone supervised learning to predict relative structural parameter coordinates.

Next, in (c), measurement spectral distribution data obtained by measuring a sample is input as shown in FIG. 3.

Here, the measurement spectral distribution data may include a measurement spectral distribution.

Next, referring to FIGS. 3 to 5, (d), in which the measurement spectral distribution data includes the measurement spectral distribution, includes: (d1) selecting similar library variable measurement parameter coordinates (=paired node) corresponding to a similar measurement spectral distribution that is close to the measurement spectral distribution among the plurality of library variable parameters and defining the coordinates as 0-order measurement coordinates; (d2) defining coordinates shifted in the positive direction by the preset interval based on the similar library variable measurement parameter coordinates as +1-order measurement coordinates; (d3) defining coordinates shifted in the negative direction by the preset interval based on the similar library variable measurement parameter coordinates as −1-order measurement coordinates; and (d4) generating the synthetic data by combining the measurement spectral distribution, the spectral distribution corresponding to the +1-order measurement coordinates, and the spectral distribution corresponding to the −1-order measurement coordinates.

In (d1), the similar library variable measurement parameter coordinates (Pn1, Pn2) are represented as (Pn1, Pn2) as matching similar data in the library, as shown in FIG. 3.

Next, in (d2) and (d3), the positive (+) measurement coordinates and the negative (−) measurement coordinates are selected by the artificial neural network supervised learning in (b).

Next, in (d4), the measurement spectral distribution is a measurement spectral distribution combined with library data, as shown in FIGS. 3.

As (d1) to (d4) are performed, the synthetic data in which the measurement spectral distribution, the spectral distribution corresponding to the +1-order measurement coordinates, and the spectral distribution corresponding to the −1-order measurement coordinates are combined are illustrated in FIG. 3 (matching and combined library data) and FIG. 5 (sample spectral distribution in the input layer, +1-order spectral distribution, −1-order spectral distribution).

Next, referring to FIG. 5, in step (e), when the synthetic data is input to the supervised learning artificial neural network illustrated in FIG. 3, the relative structural parameter coordinates (Pr1, Pr2) are predicted (predict relative structural parameter illustrated in FIG. 3).

Next, referring to FIGS. 3 and 5, in (f), the similar variable measurement parameter coordinates (Pn1, Pn2) for the similar library spectral distribution data and the predicted relative structural parameter coordinates (Pr1, Pr2) are combined to finally output the actual variable parameter coordinates (Pn1+Pr1, Pn2+Pr2).

Through the process, an algorithm capable of analyzing nanostructure of an unknown specimen is driven, and parameters to be analyzed can be analyzed through parameterization for various information such as structural information as well as optical and material information.

Specifically, as described above with reference to FIGS. 4A and 4B, the prediction method for the parameters of height and width has been exemplarily explained, but is not limited thereto, and the number of predicted parameters can vary depending on the number of variable parameters defined in advance.

In addition, as described above with reference to FIG. 4B, the grid having a preset interval was described as a square, but is not limited thereto, and of course, this can have an n-dimensional regular polytope shape (wherein n is a natural number greater than or equal to 2) having a specific preset interval.

In addition, with reference to FIG. 2B, the disclosure provides a recording medium storing a computer program for implementing a method for predicting a parameter of a sample in an optical measurement system according to the above.

In addition, the disclosure provides a computer program stored in a recording medium for implementing a method for predicting a parameter of a sample in an optical measurement system according to the above.

The description of the disclosure is for illustrative purposes, and those skilled in the art will understand that it can be easily modified into other specific forms without changing the technical idea or essential features of the disclosure. Therefore, the embodiments described above should be understood as being exemplary in all respects and not limiting. For example, each component described as a single type may be implemented in a distributed manner, and likewise, components described as distributed may be implemented in a combined form.

The scope of the disclosure is indicated by the following claims, and all changes or modifications derived from the meaning and scope of the claims and their equivalent concepts should be interpreted as being included in the scope of the disclosure.

1. A method for predicting a parameter of a sample in an optical measurement system, the method comprising:
generating a first set of a plurality of library spectral distribution data;
supervising learning of an artificial neural network with the first set of the plurality of library spectral distribution data;
inputting measurement spectral distribution data acquired by measuring the sample;
generating synthetic data by combining the measurement spectral distribution data and a second set of a plurality of library spectral distribution data that are similar to the first set of plurality of library spectral distribution data;
inputting the synthetic data into the artificial neural network to predict structural parameter coordinates; and
combining variable measurement parameter coordinates for the second set of plurality of library spectral distribution data and the structural parameter coordinates to output actual variable parameter coordinates.

2. The method of claim 1, wherein
the generating the first set of the plurality of library spectral distribution data comprises:
assuming structural features and optical features for the sample;
determining a number of library variables for the structural features and optical features; and
forming coordinates on a plane composed of a plurality of library variable parameters according to the number of library variables, and
wherein in the forming the coordinates on the plane,
a x-axis of the plane is a height of the sample and a y-axis of the plane is a width of the sample.

3. The method of claim 2, wherein
(a) the generating the first set of the plurality of library spectral distribution data comprises:
forming a plurality of grids having predetermined intervals on the plane in a direction of the plurality of library variable parameters;
obtaining a first spectral distribution for first library variable parameter coordinates located at each vertex of the plurality of grids based on the predetermined intervals for each of the plurality of grids; and
generating the first set of the plurality of library spectral distribution data by dividing and storing the plurality of library variable parameters obtained from the first spectral distribution for the first library variable parameter coordinates for the each of the plurality of grids,
wherein the each of the plurality of grids has a shape of a n-dimensional regular polytope, and n is a natural number greater than or equal to 2.

4. The method of claim 3, wherein
the supervising the learning of the artificial neural network comprises:
selecting second library variable parameter coordinates corresponding to a second spectral distribution that is close to a first measurement spectral distribution among the plurality of library variable parameters and defining the second library variable parameter coordinates as 0-order coordinates;
defining coordinates shifted in a positive direction by one of the predetermined intervals based on the second library variable parameter coordinates as +1-order coordinates;
defining coordinates shifted in a negative direction by one of the predetermined intervals based on the second library variable parameter coordinates as −1-order coordinates; and
supervising learning of the artificial neural network to derive the structural parameter coordinates based on the measurement spectral distribution, and a third spectral distribution corresponding to the +1-order coordinates, and a fourth spectral distribution corresponding to the −1-order coordinates.

5. The method of claim 3, wherein
the generating the synthetic data comprises:
selecting library variable measurement parameter coordinates corresponding to a second measurement spectral distribution that is close to a first measurement spectral distribution among the plurality of library variable parameters and defining the library variable measurement parameter coordinates as 0-order measurement coordinates;
defining coordinates shifted in a positive direction by one of the predetermined intervals based on the library variable measurement parameter coordinates as +1-order measurement coordinates;
defining coordinates shifted in a negative direction by one of the predetermined intervals based on the library variable measurement parameter coordinates as −1-order measurement coordinates; and
generating the synthetic data by combining the second measurement spectral distribution, a third spectral distribution corresponding to the +1-order measurement coordinates, and a fourth spectral distribution corresponding to the −1-order measurement coordinates.

6. A recording medium storing a computer program for implementing the method for predicting the parameter of the sample in the optical measurement system according to claim 1.

7. A computer program stored on a non-transitory recording medium for implementing the method for predicting the parameter of the sample in the optical measurement system according to claim 1.
